(19) United States
(12) Patent Application Publication
(10) Pub. No.: US 2022/0400660 A1
(43) Pub. Date: Dec. 22, 2022

(54) Crankbait Fishing Lure

(71) Applicant: DQC International Corp., Clearwater, FL (US)

(72) Inventors: Richard Michael Teschendorf, Palm Harbor, FL (US); Matt Racine, Tampa, FL (US)

(21) Appl. No.: 17/352,769

(22) Filed: Jun. 21, 2021

(51) Int. Cl. A01K 85/01; A01K 85/18

(52) U.S. Cl. CPC A01K 85/01; A01K 85/18

(57) ABSTRACT

A fishing lure including a body that includes a head portion, a tail portion, a top side, a bottom side; a transverse slot located at the head portion of the body; a metallic lip pivotably connected to and extending away relative to the slot; a metallic insert placed between the metallic lip and the slot; a connector pivotally connecting the lip to the slot; and at least one eyelet connected to the body.

### FIELD OF THE INVENTION

The present invention relates generally to fishing lures. More particularly, the present invention relates to a crankbait fishing lure capable of emitting sounds to attract fish.

### BACKGROUND OF THE INVENTION

Fishing is a very popular sport for many people. In recent years, the development of new artificial fishing lures has increased significatively, especially in the fishing industry.

Crankbait fishing lures are one of the most commonly used lures to simulate the underwater appearance of a fish. The crankbait fishing lure wobbles as it moves through the water creating the illusion that the crankbait is swimming or propelling itself through the water, which attracts the fish.

Crankbait fishing lures come in many colors, shapes, and sizes. Crankbait fishing lures generally include a hard plastic body molded into the shape of a small fish; a lip or bill that protrudes from the front of the body and that dictates the swimming performance of the lure; and at least one treble eyelet attached to the body via a conventional fastener, for example, screw eyes. As you crank your reel, the lip creates resistance and drags the bait underwater.

Although numerous crankbait fishing lures use a lip, the lip of the prior art is held on a fixed position with respect to the body when the lures move through the water. Unfortunately, this prevents the crankbait fishing lures from performing certain fish attracting motions, vibrations, and sounds as the lure moves through the water.

The prior art shows the use of a noise making device especially designed to be placed inside or attached to the body of the crankbait fishing lure. Unfortunately, adding these devices into the body of the lure will require either a permanent modification of the crankbait fishing lure or to be attached at a distance from the lure, which will allow the lure to be tangled with seaweed and other plants under the sea.

Applicant notes that there is a need in the fishing lure art to provide a movable lip on a crankbait fishing lure that causes fish attracting vibrations and sounds as the lure moves through the water without drastically changing the mechanics of the existing lures. In addition, Applicant notes that there is a need to provide the crankbait fishing lure with a lip that oscillates or vibrates in substantially the same manner as a swimming fish, thereby serving to better lure real fish into biting.

### SUMMARY OF THE INVENTION

A crankbait fishing lure, according to an embodiment of the present invention, includes a moving metallic lip that is rigged inside a metallic insert so the lure is retrieved. Not only does the lure move, but the lip slides back and forth creating a metallic clicking noise and a resonance that attracts the fish. In addition, the metallic lip also helps to create a super strong oscillation and vibration and gives the lure the ability to wildly deflect.

The fishing lure including a body, that includes a head portion, a tail portion, a top side, a bottom side; a transverse slot located at the head portion of the body; a metallic lip pivotably connected to and extending away relative to the slot; a metallic insert placed between the metallic lip and the slot; a connector pivotally connecting the lip to the slot; and at least one eyelet connected to the body.

### BRIEF DESCRIPTION OF THE DRAWINGS

For greater clarity and understanding of the present invention, it has illustrated in several figures that represent the preferred manner of preparation, all for example, where:

FIG. 1 shows a perspective front view of the crankbait fishing lure according to an embodiment of the present invention;

FIG. 2 shows a side view of the crankbait fishing lure according to FIG. 1;

FIG. 3 shows a perspective bottom view of the crankbait fishing lure according to FIG. 1;

FIG. 4 shows a top view of the crankbait fishing lure according to FIG. 1;

FIG. 5 shows a bottom view of the crankbait fishing lure according to FIG. 1;

FIG. 6 shows a front view of the crankbait fishing lure according to FIG. 1;

FIG. 7 shows a back view of the crankbait fishing lure according to FIG. 1;

FIG. 8A shows an internal view of the body of the crankbait fishing lure according to FIG. 1 showing the lip, metallic insert, connector, and eyelets attached;

FIG. 8B shows an internal view of the body of the crankbait fishing lure according to FIG. 1 without the showing the lip and eyelets attached;

FIG. 8C shows another internal view of the body of the crankbait fishing lure according to FIG. 1 without showing the lip and eyelets attached;

FIG. 8D shows another internal view of the body of the crankbait fishing lure according to FIG. 1 without showing the lip and eyelets attached;

FIG. 9 shows a perspective front view of the metallic lip according to the present invention;

FIG. 10 shows a detailed view of the crankbait fishing lure of the present invention, showing the connection between the metallic lip, metallic insert, connector on the slot of the body;

FIG. 11 shows another detailed view of the crankbait fishing lure of the present invention, showing the connection between the metallic lip, metallic insert, connector on the slot of the body;

FIG. 12 shows a perspective bottom view of the metallic lip connected to the metallic insert and the connector according to the present invention;

FIG. 13 shows a perspective side view of the metallic lip of FIG. 12; and

FIG. 14 shows a front view of the of the metallic lip of FIG. 12.

### DETAILED DESCRIPTION OF THE INVENTION

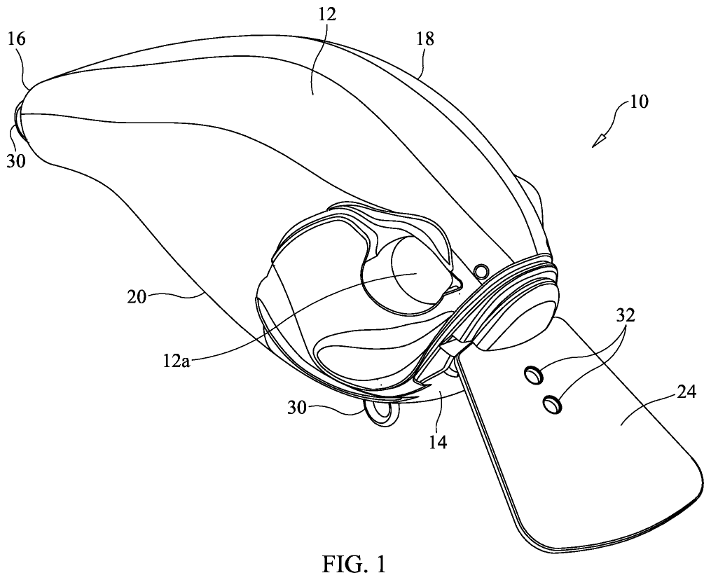

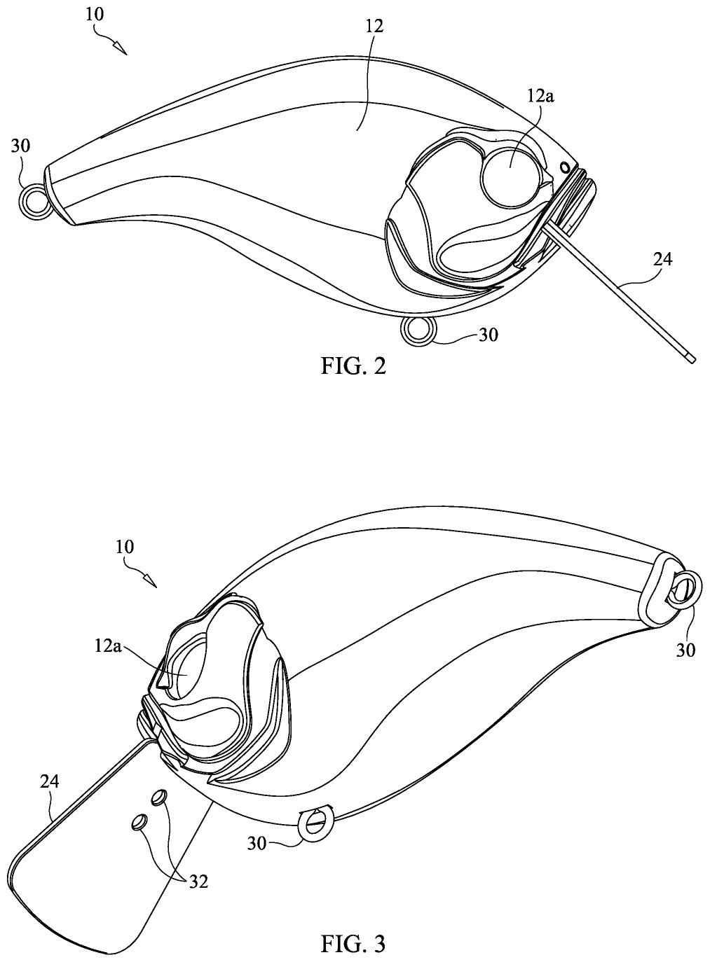

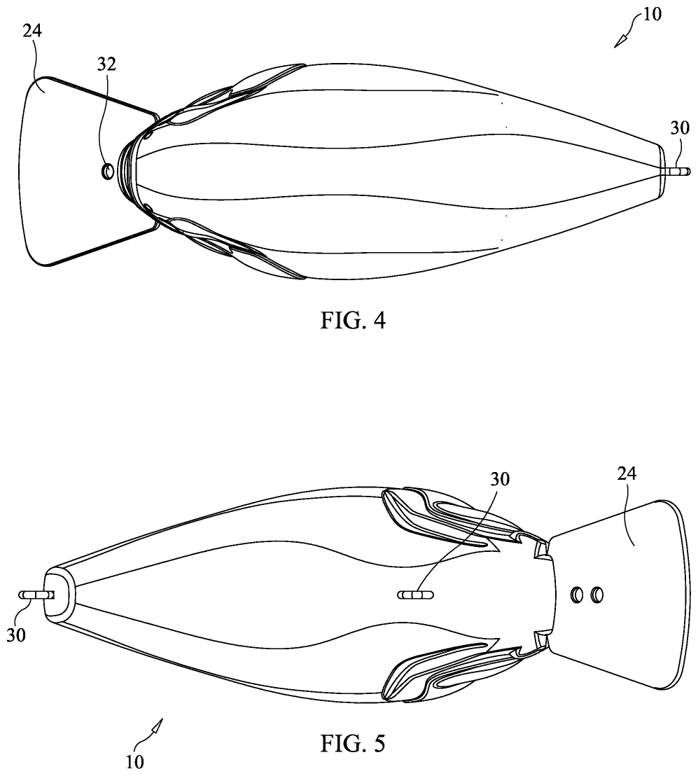

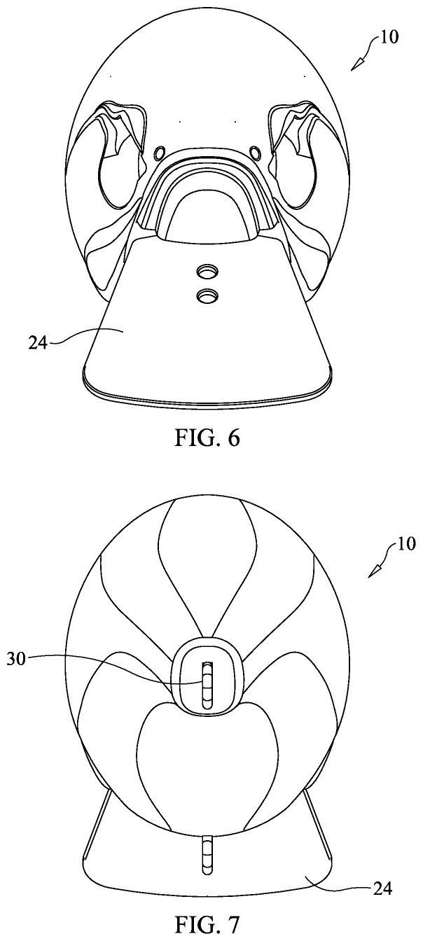

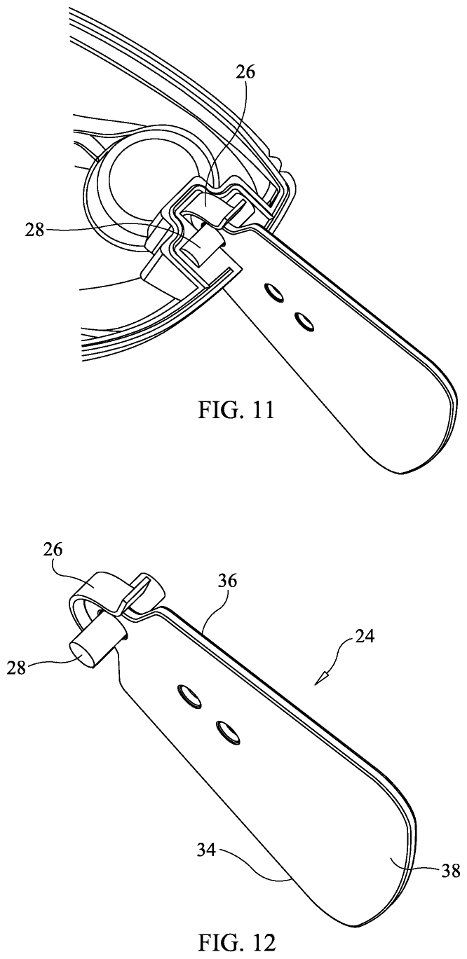

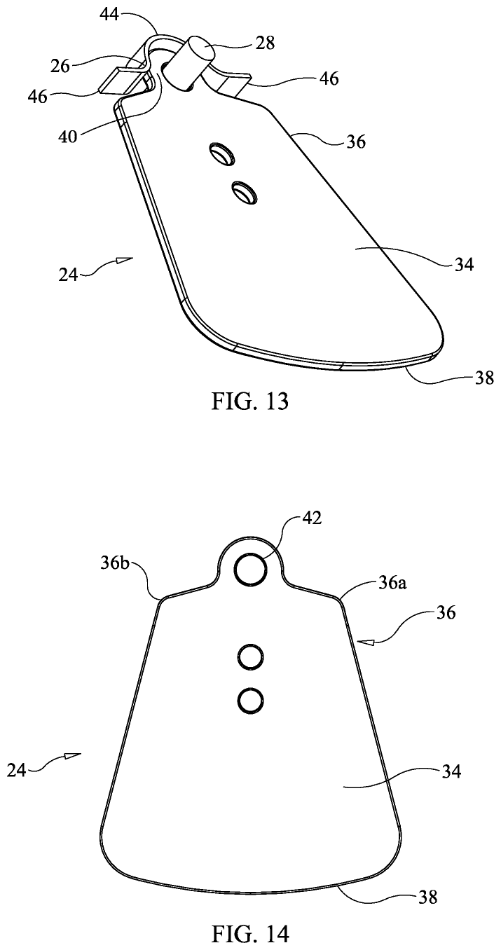

FIGS. 1-14 show a crankbait fishing lure 10 according to an embodiment of the present invention. The main feature of the crankbait fishing lure 10 is the presence of a moving metallic lip that is rigged inside a metallic insert so the lure is retrieved. Not only does the lure move, but the lip slides back and forth creating a metallic clicking noise and a resonance that attracts the fish. In addition, the square-shaped lip also helps to create a super strong oscillation and vibration and gives the lure the ability to wildly deflect.

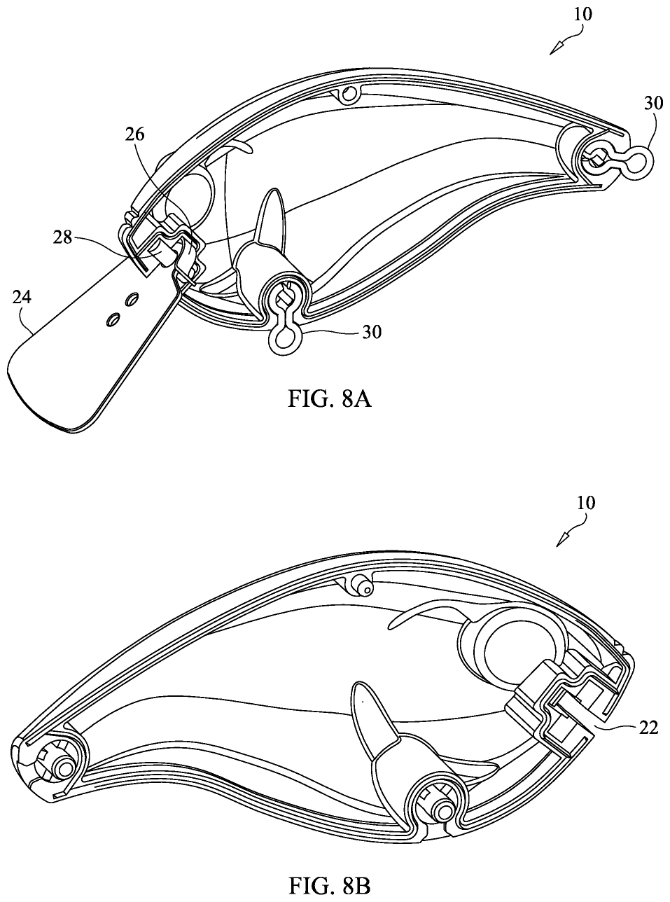

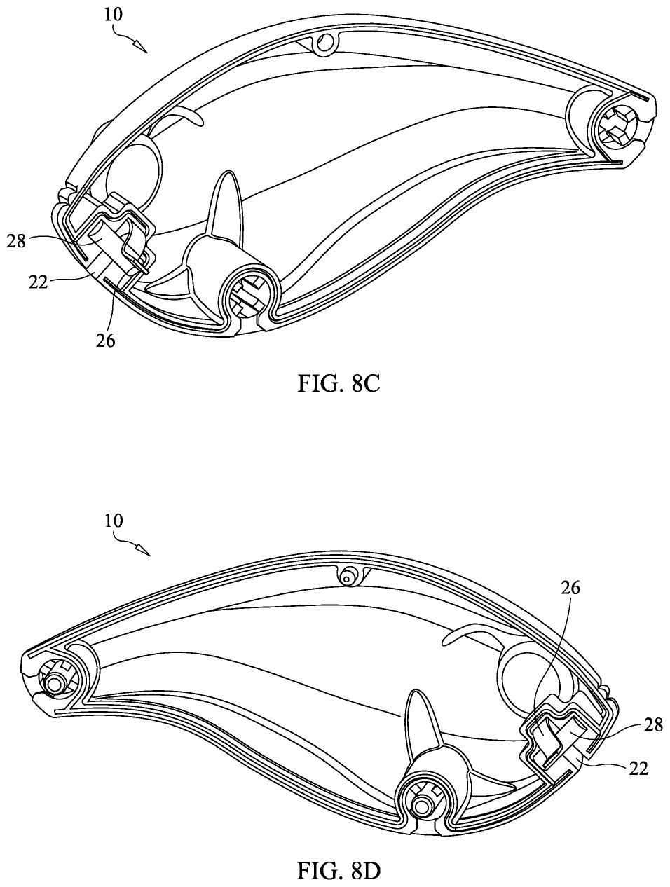

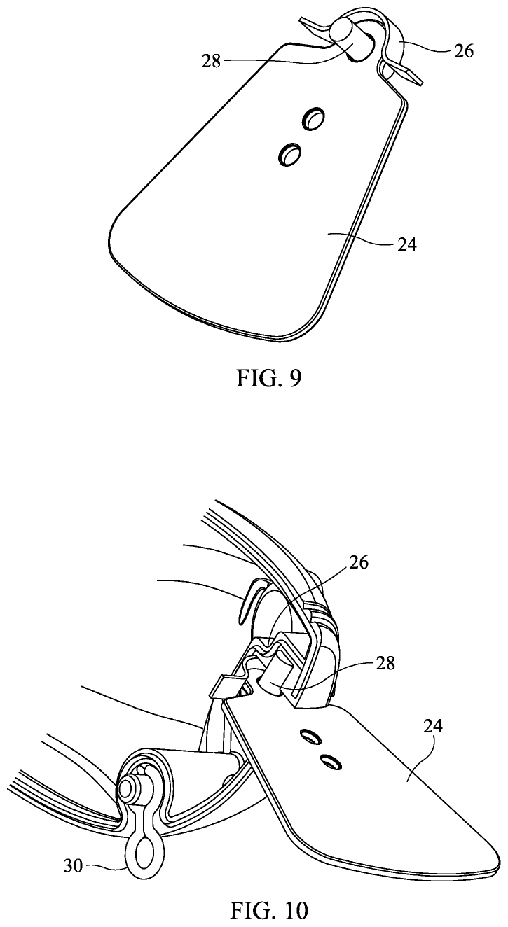

The crankbait fishing lure 10 includes a body 12, that includes a head portion 14, a tail portion 16, a top side 18, a bottom side 20; a transverse slot 22 (FIGS. 8B-8D) located at the head portion 14 of the body 12; a metallic lip 24 pivotably connected to and extends away at a downward angle relative to the transversal slot 22 of the head portion 14; a metallic insert 26 (FIGS. 9, 10, 11, 12, 13) placed between the metallic lip 24 and the transversal slot 22, and a connector 28 (FIGS. 9, 10, 11, 12, 13) for pivotally connecting the metallic lip 24 to the transversal slot 22; and at least one eyelet 30 connected to the body 12.

In one embodiment, the body 12 is made of two half-sections joined along seams in any conventional manner. In one embodiment the body 12 is a one-piece body.

The body 12 includes a head portion 14, a tail portion 16, a top side 18, a bottom side 20 and a transverse slot 22 (FIGS. 8B-8D) located at the head portion 14 of the body 12.

The body 12 may have the shape of a small fish in which the top side 18 and the bottom side 20 are curved and tapered from the head portion 14 towards the tail portion 16. The body 12 may be of any color or mixture of colors to match the shape and coloring of various types of preferred prey for game fish.

The body 12 may be made of various materials including plastics, e.g., polycarbonate or Acrylonitrile butadiene styrene material (ABS); wood, rubber, or metal, e.g., stainless steel.

The crankbait fishing lure 10 according to the present invention may have at least two eyelets 30 attached to the body 12. In one embodiment, the crankbait fishing lure 10 according to the present invention includes one eyelet attached to the body 12.

The eyelets 30 are adapted to connect a treble hook to the body 12.

The transversal slot 22 may extend across the full width of the head portion of the body 12. The inclination of the transverse slot 22 relative to the center horizontal plane of the body 12 varies depending on the depth at which the crankbait fishing lure 10 is expected to run when pulled through the water by a fishing line.

The transverse slot 22 provides a space for insertion of the metallic lip 24.

Those skilled in the art, in light of the present teachings, will recognize that various embodiments of the present invention may have various different features and construction. For example, without limitation, the body 12 may have various other shapes.

In an embodiment of the present invention, the body 12 may include a pair of tri-dimensional holographic eyes 12a. The 3D holographic eyes and high-definition paint add to the illusion of a severely wounded baitfish. Combine that wobble with that sound and it is going to attract the fish.

The metallic lip 24 pivotably connected to and extending away at a downward angle relative to the transverse slot 22 of the head portion 14 of the body 12.

The metallic lip 24 is freely pivotally mounted to the transverse slot 22 of the body 12 by using a connector 28. The connector 28 attaches the metallic lip 24 to the body 12 in a manner that permits the metallic lip 24 to pivot/move with respect to the body 12. The degree of movement of the metallic lip 24 can be controlled by changing the width of the transversal slot 22.

In the present invention, the connector 28 is a substantially vertical hinge with regards to the slot 22. However, alternate embodiments may comprise various different means for pivotally connecting the metallic lip 24 to the transversal slot 22 of the body 12.

The connector 28 may be formed from a rigid material or a semi-flexible material, for example, Carbon, acrylonitrile butadiene styrene (ABS), Aluminum, Steel, Tungsten, Brass, a polymer, a polycarbonate, carbon fiber, any metallic material and mixture thereof. The connector 28 may have any geometrical shape, preferably a cylindrical shape.

The metallic lip 24 according to the present invention differs from known prior art lips in that such lips are made of plastic and also cannot move inside the slot. In the present invention the lip 24 is made of a metal and also pivots (moves) inside the transversal slot 22.

As can been from FIGS. 12-14, the metallic lip 24 includes a flat body 34 having a first base 36 which is inserted into the transversal slot 22 of the body 12 and a second base 38 that protrudes from the transversal slot 22 of the body 12 in the direction that the crankbait fishing lure 10 travels.

The width of the flat body 34 of the metallic lip 24 decreases in size from the second base 38 towards the first base 36.

The first base 36 includes a first edge 36a and a second edge 36b. The first edge 36a and the second edge 36b extend towards the center of the first base 36 forming a round shaped central projection 40, which is the forward most extension of the metallic lip 24.

The round shaped central projection 40 includes a hole 42 (FIG. 14). The connector 28 passes through the hole 42 of the projection 40 to connect the metallic lip 24 into the transversal slot 22 of the body 12 of the crankbait fishing lure 10. The hole 42 has a diameter that is larger than the diameter of the connector 28, so the metallic lip 24 freely moves in the slot 22.

The metallic lip 24 also includes at least one orifice 32 where a fisherman may attach an eyelet loop for a fishing line. As the fisherman pulls the crankbait fishing lure 10 through the water, via a fishing line attached to the orifice 32 of the metallic lip 24, a predator fish can bite the crankbait fishing lure 10 and be eyeleted on the eyelet connected to the orifice 32.

The metallic lip 24 is preferably a one-piece body and may be optionally horizontal or bent downward at an angle from 1-130 degrees from the crankbait fishing lure 10. The metallic lip 24 is preferably made of stainless steel or any metallic material that is able to produce the desired sound.

The metallic lips 24 may be of any size or length desired that allows to extend from the body 12 at any angle required to achieve the depth of dive desired for the lure.

The pin and lip assembly is inserted to the body before 2 sides of the body is sealed together by sonic welding. Guide channels are used. If needed it can additionally be secured with friction or epoxy.

The crankbait fishing lure 10 may include a metallic insert 26. The metallic insert 26 has a central U-shaped body 44 having lateral extensions 46 protruding from each one of the ends of the U. The metallic insert 26 is pressure fitted into the transverse slot 22 and the lateral extension 46 is pressed against the side walls of the transversal slot 22 maintaining the metallic insert 26 in position. The metallic insert 26 is held in place with the combination of friction, adhesive, and sonic welding.

The metallic insert 26 may be made of any kind of material as long as the material produces the desired sound.

The round shaped central projection 40 of the first end 36 is placed on the U-shaped body 44 of the metallic insert 26 and then inside the transversal slot 22.

This arrangement causes the first edge 36a and the second edge 36b of the first end 36 of the metallic lip 24 to impact the lateral extensions 46 of the metallic insert 26 as the metallic lip 24 moves from side to side within the transversal slot 22 with sufficient force to produce vibrations that attract a fish in a manner beyond anything with which the applicant is familiar.

The oscillating movement of metallic lip 24 causes vibrations, sound, and light reflections in the water that can themselves be a source of fish attraction.

While the invention has been described with reference to particular embodiments, it is not intended to illustrate or describe herein all of the equivalent forms or ramifications thereof.

1. A fishing lure comprising:
a body including a head portion, a tail portion, a top side, a bottom side; a transverse slot located at the head portion of the body;
a metallic lip pivotably connected to and extending away relative to the slot;
a metallic insert placed between the metallic lip and the slot;
a connector pivotally connecting the lip to the slot; and
at least one eyelet connected to the body.

2. The fishing lure according to claim 1, wherein the transversal slot extends across a full width of the head portion of the body.

3. The fishing lure according to claim 1, wherein the body further comprises a pair of tri-dimensional holographic eyes.

4. The fishing lure according to claim 1, wherein the metallic lip is pivotally mounted to the transverse slot of the body by using a horizontal connector.

5. The fishing lure according to claim 1, wherein the metallic lip creates a clicking noise.

6. The fishing lure according to claim 1, wherein the metallic lip creates oscillation and vibration.

7. The fishing lure according to claim 1, wherein:
the metallic lip includes a flat body having a first base which is inserted into the transversal slot and a second base that protrudes from the transversal slot;
the flat body has a width that decreases size from the second base towards the first base; and
the first base includes a first edge and a second edge, the first edge and the second edge extend towards a center of the first base forming a round shaped central projection.

8. The fishing lure according to claim 7, wherein the round shaped central projection includes a hole, the connector passes through the hole of the projection to connect the metallic lip into the body.

9. The fishing lure according to claim 1, wherein it is made of stainless steel, carbon, acrylonitrile butadiene styrene (ABS), aluminum, steel, tungsten, brass, a polymer, a polycarbonate, carbon fiber, and mixture thereof.

10. The fishing lure according to claim 7, wherein the metallic insert has a central U-shaped body having lateral extensions protruding from each of the U.

11. The fishing lure according to claim 10, wherein the round shaped central projection of the first end is placed on the central U-shaped body of the metallic insert and then inside the transversal slot.

12. The fishing lure according to claim 7, wherein the metallic lip creates a clicking noise.

13. The fishing lure according to claim 7, wherein the metallic lip creates oscillation and vibration.
